(19) United States
(12) Patent Application Publication
(10) Pub. No.: US 2003/0184907 A1
(43) Pub. Date: Oct. 2, 2003

(54) Method for boosting a disc drive motor stiction breakaway performance

(75) Inventors: Xinwei Li, San Jose, CA (US); Huan Tang, Los Altos, CA (US); Jing Gui, Fremont, CA (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/335,732

(22) Filed: Dec. 31, 2002

Related U.S. Application Data
(60) Provisional application No. 60/368,726, filed on Mar. 29, 2002.

(51) Int. Cl. G11B 15/46; G11B 21/02

(52) U.S. Cl. 360/73.03; 360/75

(57) ABSTRACT

A method of overcoming stiction, at a head-to-disc interface, within a disc drive. The method comprises the operations of powering on the disc drive and initiating a motor spin-up routine. The motor spin-up routine involves a breakaway part, during which a spindle motor, carrying a disc in the disc drive, is driven with a spindle motor current at a first level sufficient to generate a motor torque greater than half of a maximum stiction force for a first time period in order to break stiction, and then driving the spindle motor with the spindle motor current at a second level, less than the first level after the first time period to rotate the disc. The breakaway part of the spin-up routine is followed by an acceleration part and then a normal disc rotation part during which nominal speed is maintained.

### RELATED APPLICATIONS

This application claims priority of U.S. provisional application Serial No. 60/368,726, filed Mar. 29, 2002 entitled “Method for Boosting a Drive Motor's Stiction Breakaway Performance.”

### FIELD OF THE INVENTION

This application relates generally to data storage devices and more particularly to a disc drive disc spin motor control scheme.

### BACKGROUND OF THE INVENTION

Disc drive data storage devices typically provide for a rest position for the read/write heads either on the disc or on an off disc ramp. If the heads are stored on the disc surfaces, they are positioned on a landing zone either adjacent an inner diameter or an outer diameter of the data portion of the disc. A landing zone adjacent the inner diameter is generally preferred. The drive motor control system for these drives employs a contact start-stop (CSS) sequence to load the heads onto the landing zone during power down of the drive and unload the heads off of the landing zone upon power up. When the drive is powered on, the motor must provide a sufficient torque to overcome the maximum stiction, i.e. static friction, force between the heads and the discs at their interfaces, along with the static friction or stiction inside the motor to initiate disc rotation and overcome dynamic friction forces at these interfaces as well as inside the motor, to ramp up the rotational speed of the discs to the motor's normal operating speed. Usually the spin-up routine applies a gradually increasing motor torque to the discs until the breaking of the maximum stiction force. At this point, the required motor torque must exceed the maximum total stiction force of the drive to initiate rotation.

As the form factor (size) of disc drives decreases, the maximum torque that an appropriately dimensioned motor becomes increasingly more limited for its size. At the same time, with the transition to shallow laser zone texture and to textureless landing zone media, coupled with padded sliders (parts of the heads that actually touch the discs at rest), to accommodate the ultra-low fly heights necessary for increased recording density, stiction mitigation of the head-disc-interface (HDI) has become one of the most challenging tasks in disc drive design to ensure successful drive spin-up in every CSS cycle. Numerous patents address how to break away a stuck HDI, such as the use of resonant properties of the disc system and the use of the force from the actuator arm. These methods are applied only after the detection of a stuck situation and the applied forces are not well controlled.

Accordingly, there is a need for a method for boosting a disc drive motor's capability to overcome static friction, or stiction, reliably and in a controlled manner in an operational disc drive. The present invention provides a solution to this and other problems, and offers other advantages over the prior art.

### SUMMARY OF THE INVENTION

The present invention increases the stiction breakaway capability of a disc drive system by implementing a novel motor spin up operation. Disc drive motor spin-up sequencing from rest to normal operation at nominal operational speed can be described in three parts: stiction breakaway, acceleration, and normal operation. This motor spin-up operation begins when the disc drive is energized thereby supplying power to the disc drive rotational circuitry. The disc spindle motor is then driven with the spindle motor current. In the stiction breakaway portion of the motor spin-up operation the spindle motor current is ramped immediately up to a first level. The first level is at least high enough to cause the spindle motor to generate the minimum amount of torque necessary to overcome the stiction force. The motor current is ramped up to the first level substantially instantaneously, e.g., within about 2 milliseconds. This first level may be maintained for a period of time of at least about 5 milliseconds, or until a first commutation rotational position of the motor is reached. Once stiction breakaway has occurred and the discs accelerate towards a normal operational rotation speed, the spindle motor current is decreased to a second level that is appropriate for normal disc drive operation.

Another embodiment of present invention also provides a motor spin-up operation that initially includes a reverse applied current operation. After the disc drive is powered up, a reverse ramp operation causes the initial spindle motor current to be applied at the first level, but with the polarity reversed from that needed for normal disc rotation. Then the current is applied with normal polarity. This current reversal causes the breakaway spindle motor current to be assisted by the stored spring force in the head suspension to efficiently overcome stiction in drive start-ups.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a functional block diagram of the disc drive shown in FIG. 1.

FIG. 3 is a graph of the motor and HDI stiction force versus disc displacement.

FIG. 4 is an operational flow diagram of a disc spindle motor spin-up routine to overcome stiction at a head-to-disc interface in accordance with the present invention.

FIG. 5 is an operational flow diagram of an alternative motor spin-up routine, according to the present invention, to overcome stiction at a head-to-disc interface.

### DETAILED DESCRIPTION

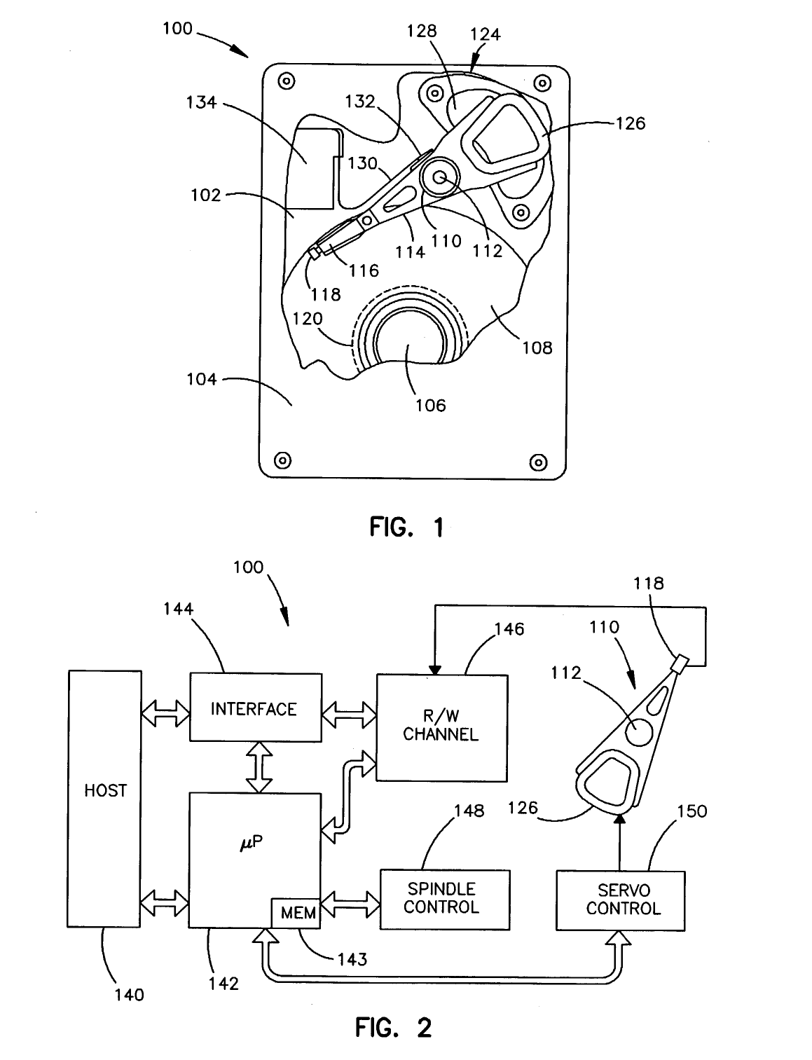

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner or outer diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

FIG. 2 is a functional block diagram of the disc drive 100 of FIG. 1, generally showing the main functional circuits which are resident on the disc drive printed circuit board and used to control the operation of the disc drive 100. The disc drive 100 is operably connected to a host computer 140 in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

During a seek operation, wherein the actuator 110 moves the heads 118 between tracks, the position of the heads 118 is controlled through the application of current to the coil 126 of the voice coil motor 124. A servo control circuit 150 provides such control. During a seek operation the microprocessor 142 receives information regarding the velocity of the head 118, and uses that information in conjunction with a velocity profile stored in memory 143 to communicate with the servo control circuit 150, which will apply a controlled amount of current to the voice coil motor coil 126, thereby causing the actuator assembly 110 to be pivoted.

Data is transferred between the host computer 140 or other device and the disc drive 100 by way of an interface 144, which typically includes a buffer to facilitate high speed data transfer between the host computer 140 or other device and the disc drive 100. Data to be written to the disc drive 100 is thus passed from the host computer 140 to the interface 144 and then to a read/write channel 146, which encodes and serializes the data and provides the requisite write current signals to the heads 118. To retrieve data that has been previously stored in the disc drive 100, read signals are generated by the heads 118 and provided to the read/write channel 146, which performs decoding and error detection and correction operations and outputs the retrieved data to the interface 144 for subsequent transfer to the host computer 140 or other device.

The discs 108 are rotated at a constant high speed by a spindle motor control circuit 148, which typically electrically commutates the spindle motor 106 (FIG. 1) preferably through the use of back electromotive force (BEMF) sensing.

During the start up of the disc drive there are forces that act on the disc besides force of the spindle motor. Stiction force is one such force that operate against the disc drive at start-up. An energy, or work, analysis as detailed below, shows that a process according to the present invention that requires the initial motor torque, applied during the breakaway part of the spin-up process, to exceed only half of the maximum stiction force, instead of the full stiction force, is effective to cause stiction breakaway. Stated another way, the motor spin-up routine, in accordance with the present invention, results in the stiction breakaway capacity of the motor to be effectively boosted by a factor of two.

The motor winding current and the magnetic field produced around the winding determine motor torque during each coil commutation. The disc only rotates a very small distance, “s’, prior to stiction breakaway. Then the head breaks loose and the disc accelerates. The breakaway happens within only a few milliseconds. Therefore, it is valid to assume the motor torque, Fₘₒₜₒᵣ, is constant during this process. If the motor current is pulse width modulated, the motor torque is the average torque with the maximum duty cycle.

The motor torque is opposed by stiction force. Stiction force is substantially linear with displacement before max stiction force is reached. Therefore:

F_{stiction}=(F_{max stiction}/max displacement)*displacement

Kinetic energy of the disc must be greater than zero at all disc displacements for the motor to break stiction successfully. Thus,

$$DiscK . E . at displacement {s}_{0} = {\int }_{0}^{{s}_{0}} ( {F}_{motor} - \frac{{F}_{max stiction}}{{S}_{max}} \cdot s ) ⅆ s > 0$$

The above equation will lead to the conclusion that the applied motor torque required to break stiction must be greater than half of the maximum stiction force.

$${F}_{motor} > \frac{1}{2} \cdot {F}_{max stiction}$$

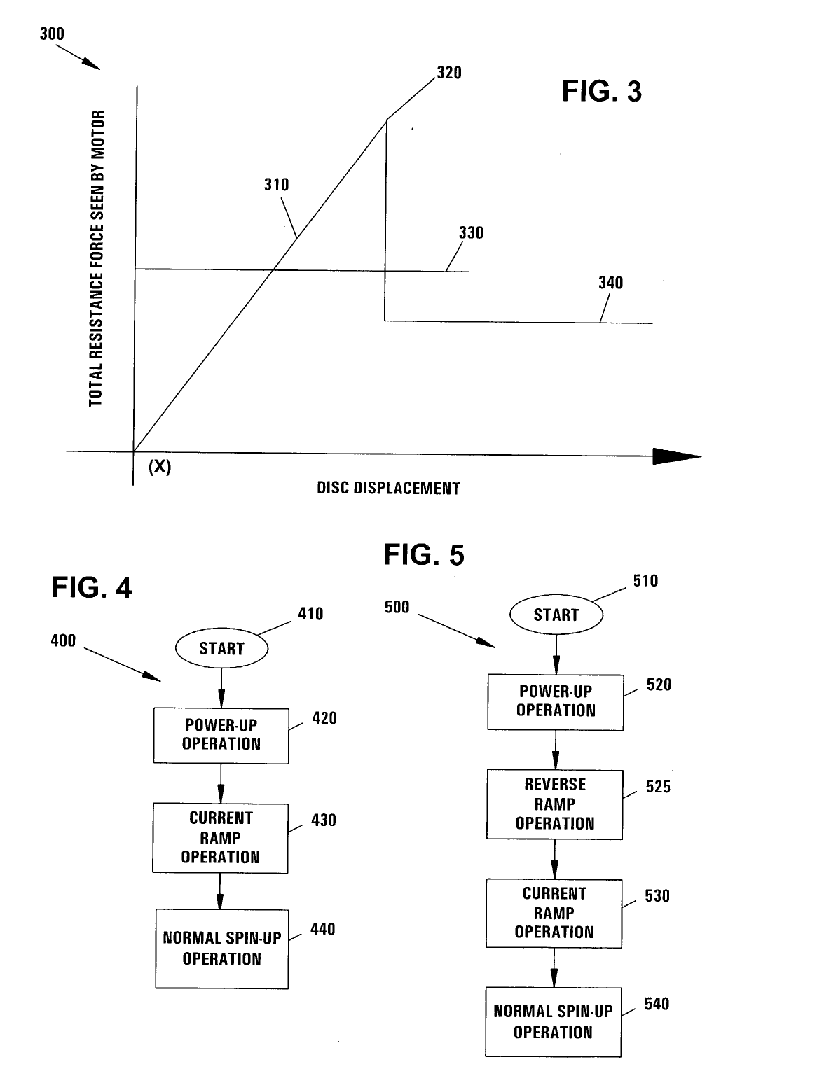

FIG. 3 is a graph of the head-to-disc interface total resistance force seen by the spindle motor 106 during the breakaway part of the spin-up routine in a disc drive. This total resistance force may be viewed as including a stiction force region 310 and spindle motor force region 340. Also shown, is the minimum motor force 330 needed to break stiction at the head disc interfaces in accordance with the present invention. When a spindle motor 106 tries to spin up the disc stack from rest, the heads 118 will initially hold the discs back due to stiction at the head-to-disc interfaces. The stiction force is proportional to both the linear displacement of the discs 108 and the spring constants of the head-suspension/actuator arm system for each HDI (114, 116 and 118). The stiction force region 310 is zero at zero displacement and increases almost linearly until breakaway stiction 320 is reached. It is really at this point that relative motion begins between the heads and the discs. From then on, the motor force 340 remains present during spinup and normal drive motor operation. The stiction force is no longer a contributor. The rate of the stiction increase in region 310 is determined by the inertia of the disc stack, the spring constant of the head suspension systems and the motor torque. The stiction breakaway 320 is approached after application of motor current in region 310. The motor current is the main factor that determines the motor torque, and it can be ramped up from zero to its maximum value, or saturated current level, substantially instantaneously, and is only limited by the time constant of the motor circuit windings.

This first level only needs to be sufficient to cause the spindle motor to generate enough torque to at least equal half of the maximum stiction force 330 and is less than the maximum stiction force 320 seen at the head-to-disc interface to overcome stiction. This initial current level is maintained until the disc stack rotates to about the first commutation position. In the case that the estimated time to the first commutation is less than a predetermined time of duration, which may be about 5 milliseconds, the initial current is maintained for at least the predetermined time of duration to guarantee the stiction breakaway to happen. This is the situation when the head rest location is not far from the first commutation position. Since there is currently no way in the motor to detect the point of breakaway (force 320) without interrupting the motor current, the initial current level must be maintained for at least a predetermined time of period to ensure breakaway occurs consistently.

In other words, the motor current is preferably fully applied to a first level within two milliseconds, and more preferably in less than one millisecond, to break stiction. This current level may then be maintained, with proper commutation, through at least the first few commutions of acceleration portion of the motor spin-up routine to normal disc operating speed. The current level may be reduced once breakaway has been achieved, and controlled at a lower level during the remainder of the acceleration part of the spin up routine.

Another embodiment of the present invention is a method to further boost the motor's stiction breakaway capacity. In this embodiment, a current of opposite polarity to that required for forward disc rotation is first applied to the motor at a level less than that necessary to break stiction to the motor for a period of less than or about five milliseconds. This current causes the disc stack to rotate in the opposite direction to that of normal disc rotation to an extent determined by the balance of the motor torque, or force, and the spring force of the head suspension system, while the heads are stuck to the disc surfaces. This stores an elastic energy in the equivalent spring of the head suspension system. The current is applied or ramped gradually so that no significant kinetic energy is transferred to the disc at any time in order not to break the interface stiction. The current polarity is then reversed to that for the normal forward disc rotational direction. This sudden reversal of the direction of the applied current causes the stored elastic energy to work together with the forward motor torque to achieve stiction breakaway. After stiction is overcome, the spindle motor current may be maintained at the first level during motor spin up to normal operating speed or it may be applied at a second level.

In one alternative embodiment, when the current polarity is reversed, the second current level, i.e. its magnitude, is retained the same as that of the first level. In another embodiment, the second level is less than the first level. The stiction breakaway capacity of the motor utilizing this method can be boosted by a factor of 3 in an ideal case, based on a similar energy analysis to that shown above.

A head stack having multiple head disc interfaces in one drive, will have multiple stiction peaks before full stiction breakaway is achieved for the head stack due to unequal stictions in these head-to-disc interfaces. Nonetheless, as a general matter, the total stiction force maintains a substantially linear relationship with the initial displacement, and thus improved stiction breakaway capacity can also be achieved utilizing the present invention in a multi-head application.

An operational flow diagram of the motor spin-up-routine 400 is illustrated in FIG. 4. The motor spin-up routine 400 shown in the operational flow diagram, begins with the discs stationary and the disc drive powered down. Power is applied to the disc drive, by user in the start operation 410. Control then transfers to power-up operation 420. Here the power supply to the disc drive is engaged and the control circuitry of the disc drive 100 is activated. At this stage in time the head 118 for each surface of the disc 108 rests on the landing zone 120 of the disc 108. Since the head 118 is in stationary contact with the disc 108 the head 118 will tend to resist the rotational movement of the underlying disc when the spindle motor 106 begins to rotate the disc 108. In other words, the phenomenon of stiction will be experienced at the head-to-disc interface.

After power is applied to the disc drive, in operation 420, control is transferred to the current ramp operation 430. Here current is substantially instantaneously applied to the motor 106. The current is applied quite rapidly, in less than five milliseconds. Typically this current is applied in less than two milliseconds, and more preferably in less than one millisecond, to a first level. The current ramp operation 430 initially applies the current to the spindle motor at the first level at least until the stiction breakaway is achieved. In this current ramp operation 430, the first level is a level sufficient cause the spindle motor to generate torque equal to more than half of, but still less than the maximum stiction force. An additional benefit of the present invention is that this method eliminates the need for having a means for detecting stiction in the disc drive system. The stiction is automatically overcome in the present invention. Once stiction has been overcome, control passes to normal spin-up operation 440. Here the head begins to fly over the data region of the disc 108 as the disc drive transitions to normal operational speed. The amount of current appplied in operation 440 may be retained at the first level or may be reduced, now that stiction is no longer present.

FIG. 5 is an operational flow diagram of an alternative motor spin-up routine 500, to overcome stiction at a head-to-disc interface, according to an alternate embodiment of the present invention. FIG. 5 is substantially the same as FIG. 4, except for the addition of the reverse ramp operation 525. The motor spin-up-routine 500 also dictates when and how the current is sent to the motor coils to initiate the disc movement. The motor spin-up routine 500 shown in the operational flow diagram, begins with the discs stationary and the disc drive powered down. Power is applied to the disc drive by user in the start operation 510. Control then transfers to power-up operation 520. Here the power supply to the disc drive is engaged and the control circuitry of the disc drive 100 is activated. At this stage in time the head 118 for each surface of the disc 108 rests on the landing zone 120 of the disc 108. Since the head 118 has been in stationary contact with the disc 108 for some time period the head 118 will tend to resist any rotational movement of the underlying disc or discs 108. In other words, the phenomenon of stiction will be experienced at the head-to-disc interface.

After power is applied to the disc drive, in operation 520, control is transferred to the reverse ramp operation 525. The reverse ramp operation 525 drives the spindle motor with a spindle motor current of reverse polarity, i.e., opposite of the polarity necessary for forward disc rotation. This current applied is ramped up, preferably more slowly, to a level sufficient to displace the disc without breaking stiction. Elastic energy is thus stored in the spring-like elements of the head suspension system. This current of opposite polarity is applied for an appropriate, pre-determined time period, which may be less than about five milliseconds. This time period may be also be less than two milliseconds. After the current of reverse polarity is applied for the predetermined period, control passes to the current ramp operation 530.

During the current ramp operation 530 the spindle motor current's polarity is reversed. This current of polarity for forward rotation now works with the release of elastic energy stored in the spring elements of the head suspension system to affect stiction breakaway. The application of current in the forward direction is fully applied within 2 milliseconds, and is preferably applied in less than 1 millisecond. This forward current is applied at a first current level for a sufficient period of time until stiction breakaway is achieved. Because of the help received by the energy stored in the suspension system, the motor torque needed to be developed by this first current level is only about half the torque needed to overcome the effects of stiction. Thus in this embodiment, the current level required is less than that required in the first embodiment. Thus the breakaway capacity is increased over that of the first embodiment discussed above.

Once stiction has been overcome controls passes to the spin-up normal operation 540, wherein the spindle motor is preferably driven with a current either retained at the prior level or reduced to a level less than the first or second level. In operation 540 the disc's rotational speed is increased to normal operational speed while heads fly over the data regions of the discs 108.

The present invention provides a method (such as 400) of overcoming stiction at a head-to-disc interface within a disc drive (such as 100). By substantially instantaneously driving a spindle motor (such as 106), carrying a disc (such as 108) in the disc drive (such as 100), with a spindle motor current for a first time period and at a first level sufficient to generate a motor torque greater than half of a maximum stiction force. In one embodiment of the present invention the spindle motor current is ramped up to a first level in less than two milliseconds, and the first time period is less than five milliseconds. The method (such as 400) still further includes driving the spindle motor (such as 106) with the spindle motor current at a second level, equal to or less than the first level, after the first time period to rotate the disc (such as 108). According to the present invention, the method (such as 400) may include a first level that generates a torque equal to the maximum stiction force. The method (such as 400) may include a second level that is sufficient to drive the motor (such as 106) at a normal operational spindle motor speed.

One embodiment of the present invention provides a method (such as 500) of breaking stiction occurring at a head-to-disc interface within a disc drive (such as 100) having a spindle motor (such as 106) carrying at least one data storage disc (such as 108). The method involves powering on the disc drive (such as 100). The method (such as 500) also involves initiating a motor spin-up routine (such as 500). The motor spin-up routine (such as 500) includes substantially instantaneously driving a spindle motor (such as 106) with a spindle motor current at a first level sufficient to generate a motor torque greater than half of a maximum stiction force, and of a first polarity. An exemplary spindle motor current is ramped up to a first level in less than two milliseconds. The routine (such as 500) also includes driving the spindle motor (such as 106) with the spindle motor current at a second level and a second polarity. The method (such as 500) still further involves driving the spindle motor (such as 106) with the spindle motor current at a third level, wherein the third level is less than the first level. The method (such as 500) may include a third level that is a normal operational spindle motor current. The method (such as 500) may include maintaining the spindle motor current level for a pre-determined period of time. The method (such as 500) may include a second level current is equal to the first level current, but opposite in polarity.

Another embodiment of the present invention provides a Contact-Start-Stop disc drive (such as 100) having a disc spindle motor (such as 106) mounted on a base plate (such as 102), the spindle motor (such as 106) carrying rotatable discs (such as 108). The disc drive includes a voice coil motor (such as 124), coupled to an actuator assembly (such as 112) mounted on the base plate (such as 102), adjacent the discs (such as 108) for moving transducer heads (such as 118) over the rotatable discs (such as 108). The disc drive further includes means (such as 106) for overcoming head-to-disc interface (HDI) stiction during drive start-up. The disc drive (such as 100) may include means (such as 106) for overcoming HDI stiction. The disc drive (such as 100) may include means (such as 106) for substantially instantaneously applying greater than half of a maximum stiction force current to the spindle motor (such as 106). The greater than half of a maximum stiction force current is applied for a period of less than five milliseconds. The disc drive (such as 100) may include a current that is greater than half the maximum stiction force current is applied for a pre-determined time period. The disc drive (such as 100) may include a current greater than half the maximum stiction force current is first applied in a first, reversed rotational direction. The disc drive (such as 100) may include a current greater than half the maximum stiction force current is secondly applied in a second, forward rotational direction.

It will be clear that the present invention is well adapted to attain the ends and advantages mentioned as well as those inherent therein. While presently preferred embodiments have been described for purposes of this disclosure, various changes and modifications may be made which are well within the scope of the present invention. For example, the time periods at the first, second and third current levels may be empirically determined for a particular class of disc drives. Another exemplary variation that is still within the scope of the present invention is that the time period for reaching the first level may be less than a millisecond. Similarly, the current level during the reversed polarity current application may be less than the maximum current and still be within the purview of the present invention. Numerous other changes may be made which will readily suggest themselves to those skilled in the art and which are encompassed in the spirit of the invention disclosed and as defined in the appended claims.

What is claimed is:

1. A method of overcoming stiction at a head-to-disc interface within a disc drive comprising steps of:
initiating a spindle motor spin-up routine; and
driving the spindle motor, carrying a disc in the disc drive, with a spindle motor current at a first level sufficient to generate a motor torque greater than half of a maximum stiction force but equal to or less than the maximum stiction force within five milliseconds of initiating the spin-up routine.

2. The method of claim 1, wherein the method further comprises a step of driving the spindle motor with spindle motor current at a second level less than or equal to the first level, to rotate the disc.

3. The method of claim 1, wherein the first level generates a torque equal to the maximum stiction force.

4. The method of claim 1, wherein the second level is sufficient to accelerate the motor to a normal operational spindle motor speed.

5. A method of breaking stiction occurring at a head-to-disc interface within a disc drive having a spindle motor carrying at least one data storage disc, the method comprising operations of:
(a) powering on the disc drive;
(b) initiating a motor spin-up routine, comprising:
(b1) driving the spindle motor with a spindle motor current having a first polarity at a first level sufficient to generate a motor torque greater than half of a maximum stiction force;
(b2) driving the spindle motor with the spindle motor current having a second polarity at a second level; and
(c) driving the spindle motor with the spindle motor current at a third level, wherein the third level is less than the first level.

6. The method of claim 5, wherein the third level is a normal operational spindle motor current.

7. The method of claim 5, wherein driving operation (b1) comprises maintaining the spindle motor current at the first level level for a pre-determined period of time.

8. The method of claim 5, wherein the first and the second levels are equal but opposite in polarity.

9. The method of claim 8, wherein the third level accelerates the spindle motor to a normal operating speed.

10. The method according to claim 7 wherein driving operation (b2) comprises maintaining the spindle motor current at the second level for another predetermined period of time.
